(19) United States
(12) Patent Application Publication
(10) Pub. No.: US 2012/0267444 A1
(43) Pub. Date: Oct. 25, 2012

(54) ARTIFICIAL FREEZING APPARATUS AND FREEZING METHOD THEREFOR

(76) Inventor: Hi-Ryong Byun, Busan (KR)

(21) Appl. No.: 13/386,983

(22) PCT Filed: Dec. 22, 2010
(86) PCT No.: PCT/KR10/09189

§ 371 Date: Jan. 25, 2012

(30) Foreign Application Priority Data
Oct. 6, 2010 (KR) 1020100097532

(51) Int. Cl. F25D 23/10; A01G 15/00

(52) U.S. Cl. 239/2.1; 62/260

(57) ABSTRACT

The present invention relates to an artificial freezing apparatus and a freezing method therefor. The present invention includes a supporter for vertically moving a water ice maker over and under the surface of water; and the water ice maker for producing an ice while being vertically moved by the supporter and to fall down thus-produced ice into the surface of water. In accordance with the present invention as described above, the present invention can separate some from the water and expose it to the atmosphere to naturally freeze the separated water and return thus-produced ice to the surface of water to thereby accelerate the freezing process on the surface and thus make some ice on the surface when it is difficult to ice, and creating various additional effects such as preventing global warming, preserving ecosystems and the like.

### FIELD OF THE INVENTION

The present invention relates to an artificial freezing apparatus; and, more particularly, to a freezing apparatus which artificially raises some water from the surface of the water (e.g., sea water or fresh water), changes it into ice in the air and return the ice to the surface of the water when the water does not freeze even when temperatures of water and air are below zero. Resultantly, the present invention relates to an artificial freezing apparatus and a freezing method therefor, capable of producing a great deal of ice by improving a freezing process to make some ice on the surface of the water that is difficult to freeze or to grow thin icy layers on the surface of the water to be thicker, and creating various additional effects (e.g., preventing global warming, preserving ecosystems and the like).

### BACKGROUND OF THE INVENTION

The present invention relates to an artificial freezing apparatus and a freezing method therefor.

Today, the ice on the Arctic Ocean has rapidly become melted, which causes the global warming to deteriorate. For example, it is reported that polar bears are in danger of extinction on the Hudson Bay in Canada since the amount of ice become reduced in the winter.

However, no attempt has been made to increase the amount of ice on the winter sea. Indeed, there are a great number of days at which the water in the sea does not freeze even when both of the temperatures of the water and the atmosphere are below zero. This is because the sea water has a maximum specific gravity that is greater than those of the fresh water and, thus, when the sea water gets cold, it starts to sink down into the sea.

Accordingly, the prevent inventor disclosed some inventions (see, e.g., Korean Patent application Nos. 10-2009-0072310, 10-2009-0052391, and 10-2007-0071924).

In Korean patent application No. 10-2009-0072310, there was disclosed “apparatus and method for in-water-production and keeping of ice in the sea” as one of good solutions for increasing the amount of ice in the sea. However, this invention is disadvantageous due to the following requirements. A ship is required to be provided on the sea. High waves of the sea cause the effects of the invention to be reduced. It is also necessary to supply the fresh water to the ship. Finally, it is not easy to avoid an increase in the equipment cost.

In the meantime, it is sometimes the case that even the fresh water does not freeze at an atmosphere whose temperature is below zero during a non-freezing time period. This is because the water temperature is not decreased to below zero due to deep water or transmission of terrestrial heat, or mixture of flowing waters. Until now, there has been suggested no method for artificially producing ice during the non-freezing time period. However, a method for freezing the water by using a natural cold heat in the winter has been disclosed in the following Korean Patent application.

In Korean Patent application No. 10-2009-0052391, there disclosed “apparatus for in-water-production and keeping of ice in reservoir.” This invention is applied to only the fresh water in the closed area with a high equipment cost. Furthermore, this obtains its effectiveness only at a significantly low temperature.

Finally, in Korean Patent application No. 10-2007-0071924 there disclosed “method for ice keeping in reservoir.” This also obtains its effectiveness only at a significantly low temperature.

### SUMMARY OF THE INVENTION

In view of the above, the present invention provides an artificial freezing apparatus and a freezing method therefor, which separates some of the water (e.g., sea water or fresh water) from the surface of the water in the air and freezes it by using the temperature below zero in the air and, then, floats the thus-produced ice on the surface of the water in order to make some ice on the surface of the water that is difficult to freeze or to grow thin icy layers on the surface to be thicker to thereby produce a great deal of ice and create various additional effects, when the water does not freeze even at a temperature below zero.

The present invention also provides an artificial freezing apparatus and a freezing method therefor, capable of performing an artificial freezing process effectively in freezing the sea water and being applied to the fresh water in a lake, a reservoir, or the like as well as the sea water.

In accordance with an aspect of the present invention, there is provided an artificial freezing apparatus including a supporter configured to vertically move a water ice maker over and under the surface of a water; and the water ice maker configured to produce an ice while being vertically moved by the supporter and to fall down a thus-produced ice into the surface of the water.

At this time, the water ice maker may include an upper cooling fan having a recessed portion for accommodating some water to be frozen; a lower cooling fan having a recessed portion for accommodating some water to be frozen; and a bimetal disposed between the upper and the lower cooling fan and configured to transform for itself depending on a temperature difference between an atmosphere and the water. The transformation of the bimetal may help to fall down the ices produced in the cooling fans into the surface of the water.

Fluorine resin Teflon may be coated on the inside of each of the cooling fans to easily separate therefrom the ices produced on the cool fans.

In the meantime, the supporter may include a fixed support; a vertical reciprocating member disposed on the fixed support and configured to be vertically moved along the fixed support over and under the surface of the water by receiving a driving force of a first chain; and a connecting member configured to connect the vertical reciprocating member to the water ice maker.

At this time, the supporter may further include a rotary member configured to rotate positions of the cooling fans by receiving a driving force of a second chain.

Meanwhile, the supporter may further include a crushing member configured to crush an ice attached on a surface of the fixed support when the vertical reciprocating member is vertically moved along the fixed support.

In accordance with another aspect of the present invention, there is provided an artificial freezing method used for an artificial freezing apparatus. The method include (A) moving downwardly a vertical reciprocating member under the surface of a water by receiving a driving force of a first chain; (B) rotating positions of an upper and a lower cooling member by receiving a driving force of a second chain when the vertical reciprocating member is moved downwardly under the surface of the water in step (A); (C) putting the apparatus on standby while an ice produced in the upper cooling fan is fallen down into the surface of the water; and (d) moving upwardly the vertical reciprocating member over the surface of the water by receiving the driving force of the first chain when some water is accommodated in the lower cooling fan whose position is switched to face upwardly in step (B).

The method may further includes repeating a vertical reciprocating movement of the vertical reciprocating member a predetermined number of times by receiving the driving force of the first chain when the ice produced in the upper cooling fan is not fallen down into the surface of the water.

In accordance with the present invention, when the surface of the sea water is not frozen even though both temperatures of the atmosphere and the sea water are below zero, the following processes are repeatedly carried out. Some water is separated from the surface of the sea water and frozen by being exposed to the atmosphere, and the thus-produced ice is fallen down into the surface of the sea water. In this way, the surface of the sea water can be started to be frozen more quickly and much more amount of ice can be obtained as compared with the case that the surface of the sea water is left to be naturally frozen.

Once the surface of the sea water is frozen, the thus-produced ice is grown for itself by absorbing fresh water ions from the sea water. Further, once the surface of the sea water is frozen, more solar heat is reflected so that the surrounding temperature is decreased to thereby accelerate the ice formation. Besides, when the surface of the sea water is left to be unfrozen, all the winter rain or snow is melted away into the sea water. However, in accordance with the present invention, all the winter rain or snow is frozen on the ice and, thus, it is possible to obtain much more amount of ice.

Such much more amount of ice requires a longer time to be melted away so that the ice can be reserved during a longer period of time. Moreover, it is possible to prevent the extinction of polar animals such as polar bears to thereby preserve ecosystems, and the melting of polar ice caps to thereby suppress global warming.

Unlike the sea water, the fresh water is frozen at a temperature below zero and, thus, it is difficult to obtain the effect as much as that of the sea water. It is sometimes the case that the fresh water is not frozen even though the temperature of the atmosphere is below zero and the temperature of the fresh water is close to zero and, thus, the present invention can be used as the effective method. At this time, by floating onto the fresh water the ice produced in the atmosphere, some of the ice is melted away and some of the ice is reflected, to thereby decrease the temperature of the fresh water. Accordingly, the present invention is advantageous in obtaining much more amount of ice.

The present invention may also be used to make thicker icy layers on the surface of the water. Such produced large amount of ice can create various additional effects.

### BRIEF DESCRIPTION OF THE DRAWINGS

FIG. 1 is an explanation view showing the whole part of an artificial freezing apparatus in accordance with an exemplary embodiment of the present invention; and

FIG. 2 is a flow chart showing an operation of the artificial freezing apparatus in accordance with the exemplary embodiment of the present invention.

### DETAILED DESCRIPTION OF THE EMBODIMENTS

An artificial freezing apparatus in accordance with an exemplary embodiment of the present invention will now be described in detail with reference to the accompanying drawings which form a part hereof.

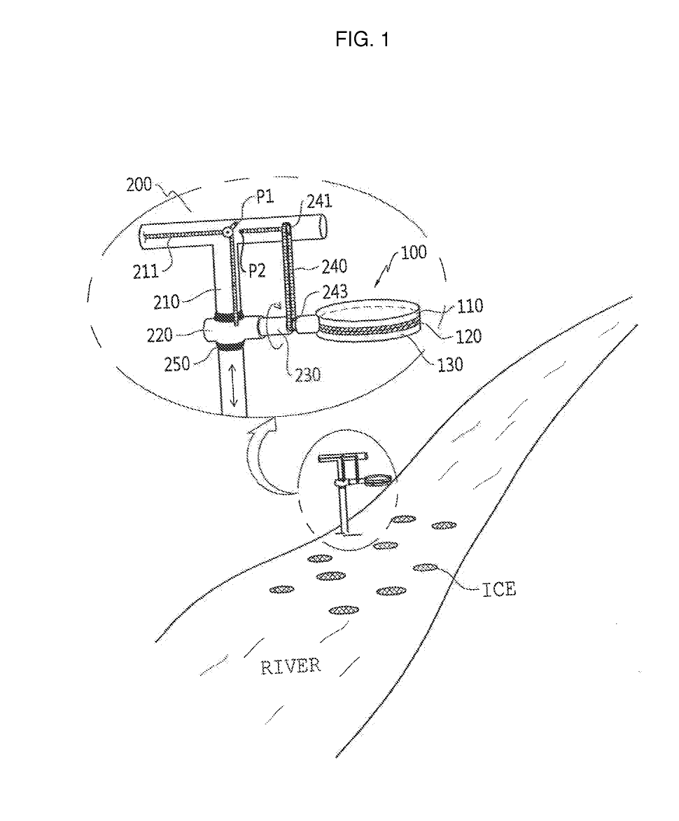

FIG. 1 is an explanation view showing the whole part of the artificial freezing apparatus in accordance with the exemplary embodiment of the present invention.

The artificial freezing apparatus of the present embodiment includes a water ice maker 100 and a supporter 200.

The water ice maker 100 produces ice while being moved upwardly and downwardly along the supporter 200 and falls down the thus-produced ice into the water. At this time, the ice produced by the water ice maker 100 is fallen down into the water to thereby improve a freezing process to make some ice on the surface of the water that is difficult to freeze or to grow thin icy layers on the surface of the water to be thicker. Hereinafter, the water ice maker 100 will be described in detail.

The supporter 200 enables the water ice maker 100 to vertically move over and under the surface of the water. The supporter 200 may be installed on the lake, the river, the sea or the like. Specifically, the supporter 200 may be fixed into the soil or the like under the water. Alternatively, another supporter may be fixed into the ground or the ship and connected to the supporter 200. Hereinafter, the supporter 200 will be described in detail.

The water ice maker 100 includes an upper cooling fan 110, a bimetal 120 and a lower cooling fan 130

The upper cooling fan 110 includes a recessed portion for accommodating therein some water to be frozen.

The bimetal 120 is disposed between the upper and the lower cooling fan 110 and 130 and transforms for itself depending on the temperature difference between the water and the atmosphere. Such transformation helps to fall down the ice produced in the cooling fans 110 and 130 into the surface of the water. In other words, the bimetal 120 responsively transforms for itself depending on the temperature difference between the water and the atmosphere to thereby transform the inner shapes of the cooling fans 110 and 130. This causes the ice produced in the cooling fans 110 and 130 to be easily fallen into the surface of the water.

Like the upper cooling fan 110, the lower cooling fan 130 also includes a recessed portion for accommodating therein some water to be frozen.

Each of the cooling fans 110 and 130 serves to accommodate and freeze some water and, then, to be rotated by 180° and release the thus-produce ice into the water.

At this time, each inside of the cooling fans 110 and 130 is preferably coated with fluorine resin Teflon to easily separate the ice from the cooling fans 110 and 130.

In the meantime, the supporter 200 includes a fixed support 210, a first chain 211, a first pulley 213, a vertical reciprocating member 220, a connecting member 230, a second chain 240, a first rotary gear 241, a second rotary gear 243 and a crushing member 250.

The vertical reciprocating member 220 is disposed on the fixed support 210 and is moved vertically over and under the surface of the water along the fixed support 210 by receiving a driving force of the first chain 211.

The connecting member 230 serves to connect the vertical reciprocating member 220 to the water ice maker 100.

Whenever the vertical reciprocating member 220 is moved upwardly and downwardly, the water ice maker 100 is vertically moved over and under the surface of the water together with the vertical reciprocating member 220 by the connecting member 230 connected to one side of the vertical reciprocating member 220 to thereby produce the ice.

A rotary member (i.e., the rotary gears 241 and 243) rotates positions of the cooling fans 110 and 130 by receiving a driving force of the second chain 240.

The crushing member 250 serves to crush the ice attached on the surface of the fixed support 210 whenever the vertical reciprocating member 220 is moved upwardly and downwardly along the fixed member 210. In general, the crushing member 250 includes a blade of knife. Since the ice attached on the fixed support 210 obstructs the upward movement of the vertical reciprocating member 220, the blade of knife is attached thereon. Further, the fixed support 210 is preferably is coated with oil or the like to prevent the ice from being attached thereon.

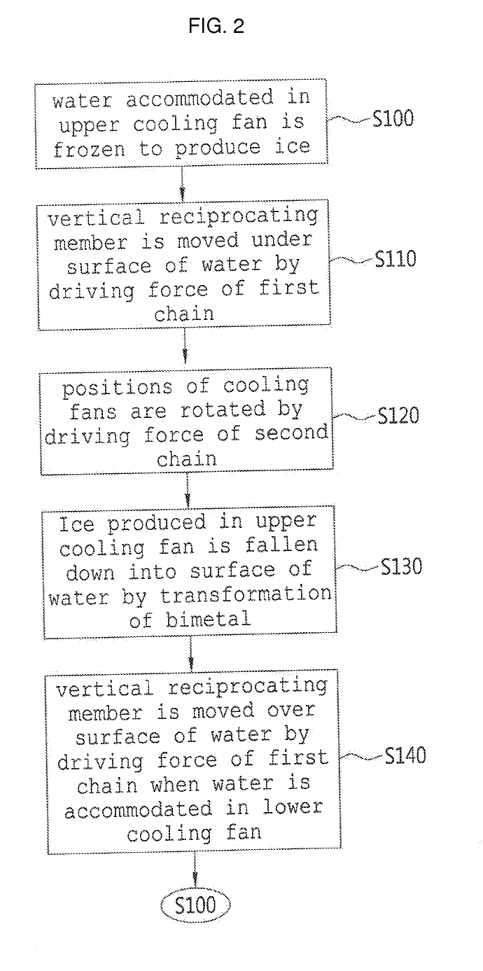

Hereinafter, an operation of the artificial freezing apparatus of the present embodiment will be described in detail with reference to FIG. 2.

FIG. 2 is a flow chart showing an operation of the artificial freezing apparatus in accordance with the exemplary embodiment of the present invention.

First, once some water accommodated in the upper cooling fan 110 is frozen by using environmental temperature (Step S100), the vertical reciprocating member 220 is moved downwardly under the surface of the water by receiving the driving force of the first chain 211 (Step S110). That is, the vertical reciprocating member 220 is downwardly moved along the fixed support 210 under the surface of the water. At this time, the temperature of the water is below zero or close to zero in the case of see water, or close to zero in the case of fresh water.

Meanwhile, a first electric contact P1 is installed at a portion of the first chain 211 that is used to control the vertical reciprocating movement of the vertical reciprocating member 220.

At this time, when the vertical reciprocating member 220 is downwardly moved under the surface of the water in step S110, the first electric contact point P1 is brought into contact with a second electric contact point P2. Then, by such contact made between the electric contact points P1 and P2, the second chain 240 is moved to thereby rotate the rotary member, i.e., the first and the second rotary gear 241 and 243, by 180° (Step S120).

Then, the upper and the lower cooling fans 110 and 130 are rotated so that the vertical positions of the cooling fans 110 and 130 are switched. Specifically, once the vertical reciprocating member 220 is moved under the surface of the water, the rotary member 241 and 243 is moved by receiving the driving force of the second chain 240 to thereby rotate the positions of the cooling fans 110 and 130. This rotation also serves to separate the ice from the cooling fans 110 and 130 and, thus, the rotation is preferably quickly performed.

In brief, the positions of the cooling fans 110 and 130 are switched by 180° so that the upper cooling fan 110 is downwardly moved and serves as the lower cooling fan 130. In the meantime, as described above, once the water ice maker 100 comes into the water, the bimetal 120 transforms due to the temperature difference between the atmosphere and the water. Such transformation of the bimetal 120 helps the frozen ice to be separated from the upper cooling fan 110 (Step S130). At this time, the separating process is accelerated by coating fluorine resin Teflon on the inside of the upper cooling fan 110. The separated ice is floated onto the surface of the water.

Thereafter, when some water is accommodated in the lower cooling fan 130 whose position is switched to face upwardly in step S120, the vertical reciprocating member 220 is upwardly moved along the fixed support 210 over the surface of the water by receiving the driving force of the first chain 211. At this time, if some ice is attached on the fixed support 210, this makes it difficult for the vertical reciprocating member 220 to be moved along the fixed support 210 and, thus, the vertical reciprocating member 220 further includes the crushing member 250 for crushing the attached ice (Step S140). If the vertical reciprocating member 220 is not moved upwardly due to the ice, the upward and downward movement of the vertical reciprocating member 220 is repeated.

Meanwhile, the present invention is operated only at a temperature below zero and, thus, the lower cooling fan 130 that is moved over the surface of the water is frozen due to the cold atmosphere. When the lower cooling fan 130 is frozen enough with the passage of time, the lower cooling fan 130 comes into the water again.

As described above, in accordance the present embodiment, it is possible to make some ice on the surface of the water that is difficult to freeze or to grow thin icy layers on the surface of the water to be thicker by separating some of the water from the surface of the water (e.g., sea water or fresh water) in the air and freezes it by using the temperature below zero in the air and, then, floating the thus-produced ice onto the surface of the water to thereby produce a great deal of ice and create various additional effects, when the water does not freeze even at a temperature below zero.

In the meantime, if the ice produced in the upper cooling fan 110 is not fallen down into the water in step S130, three steps of a separation accelerating process are further carried out.

The first step is executed by using the inertial force generated when the upper cooling fan 110 is reversed under the water and the reversed upper cooling fan 110 is moved upwardly again. The second is executed by using the gravity in order to fall down the ice into the water after the reversed upper cooling fan 110 is moved upwardly again. Finally, the third step is executed by hitting the fixed support 110, the vertical reciprocating member 220, or the upper or the lower cooling fan 110 or 130 with a hammer or the like. Such striking mechanism can be automatically or manually carried out. The corresponding description will be omitted.

Hereinafter, the operation principle of the present invention and the corresponding effects will be described in detail. The operation principle of the present invention and the corresponding effects become different depending on the kinds (i.e., sea water and fresh water) of water and, thus, the descriptions are separately made on two cases of the ea water and the fresh water.

First, the case of the sea water will be described.

The sea water is not frozen even at a temperature below zero due to the salinity included in the sea water. If it is assumed that the average salinity of sea is 35 per mill (%), the temperatures of the freezing point and maximum density of the sea are −1.8 and −3.5, respectively.

When the temperature of the sea water becomes below zero due to the low temperature of atmosphere, the cooled water sinks downwardly toward the sea floor and the relatively warmer water rises upwardly toward the surface of the sea water. Accordingly, the sea water does not freeze easily.

Further, the sea water is not frozen until its temperature reaches the temperature of −1.8. Since the whole part of the sea water in the range from the sea floor is hardly cooled below −1.8, the surface of the sea water is not easily frozen.

However, once the surface of the sea water is frozen, the thus-produced ice is not melted and is grown for itself by absorbing fresh water ions from the sea water. Further, all rain or snow falling down on the ice layers is converted into the ice.

Moreover, most of the solar heat is reflected on the ice layers to thereby positively suppress the temperature of the sea water from being raised. Accordingly, the ice layers are maintained for a long period of time. That is, once the ice layers are produced on the surface of the sea water, the ice layers are grown for themselves.

In brief, once the ice layers are produced on the surface of the sea water, it is possible to obtain a great deal of ice.

It takes a long time for the produced ice to be melted away in the spring and, thus, more solar heat is reflected to thereby suppress the global warming.

Besides, while such annual glaciers are melted away, the perennial glaciers are not melted to thereby preserve the glaciers.

Today, our ecosystems have been threatened by the side effects caused by the disappearance of ice (e.g., extinction of polar bears, destruction in ecosystem, vaporization of carbon dioxide and methane gas buried under the ice layers, and the like). However, the present invention provides the direct solution to the above problems.

In addition, the value of ice can be enhanced by freezing the sea water at small bays and the like and using the thus-produced ice for loads, storages, tourist attractions and the like.

Finally, the effects of the present invention can be doubled by using it together with the Korean Patent Application (No. 10-2009-0072310) applied by the present inventor.

Hereinafter, the case of the fresh water will be described.

At a day at which the temperature of the atmosphere is below zero and the temperature of the fresh water is close to zero, when some water is separated from the surface of the fresh water and exposed to the atmosphere, the water that is exposed to the atmosphere is frozen. If the thus-produced ice is fallen down into the surface of the fresh water, some of the ice is melted, which causes the temperature of the fresh water to be decreased to be lower. Further, since the solar heat is reflected on the ice, the temperature of the fresh water gets lower.

As described above, once the icy surface of the fresh water is formed, all the snow and the rain falling down on the icy surface is turned into the ice and thus stacked thereon. At this time, by floating the ice produced in the atmosphere onto the surface of the fresh water, the cold air in the atmosphere is gathered and transferred to the surface of the fresh water.

Accordingly, the freezing process can be accelerated even at the area at which the freezing process is hardly carried out in a natural condition.

The effects of the present invention are not decreased at any reservoir as well as flowing river. In brief, the economic values of ice can be enhanced by using the ice produced from the fresh water for winter leisure, loads and the like.

Finally, the effects of the present invention can be doubled by using it together with the Korean Patent Applications (Nos. 10-2009-0072310 and 10-2007-0071924) applied by the present inventor.

Hitherto, the exemplary embodiment of the present invention has been shown and described. However, the present invention is not limited to the embodiment. Thus, any person of ordinary skill in the art shall understand that a large number of permutations and other equivalent embodiments are possible. The true scope of the present invention must be defined only by the spirit of the appended claims.

1. An artificial freezing apparatus, comprising:
a supporter configured to vertically move a water ice maker over and under the surface of a water; and
the water ice maker configured to produce ice while being vertically moved by the supporter and to fall down the produced ice into the surface of the water.

2. The apparatus of claim 1, wherein the water ice maker includes
an upper cooling fan having a recessed portion for accommodating some water to be frozen;
a lower cooling fan having a recessed portion for accommodating some water to be frozen; and
a bimetal disposed between the upper and the lower cooling fan and configured to transform itself depending on a temperature difference between an atmosphere and the water,
wherein transformation of the bimetal helps to cause the ice produced in the cooling fans to fall into the surface of the water.

3. The apparatus of claim 2, wherein
fluorine resin Teflon is coated on the inside of each of the cooling fans to easily separate therefrom the ice produced by the cooling fans.

4. The apparatus of claim 3, wherein the supporter includes
a fixed support;
a vertical reciprocating member disposed on the fixed support and configured to be vertically moved along the fixed support over and under the surface of the water by receiving a driving force of a first chain; and
a connecting member configured to connect the vertical reciprocating member to the water ice maker.

5. The apparatus of claim 4, wherein the supporter further includes
a rotary member configured to rotate positions of the cooling fans by receiving a driving force of a second chain.

6. The apparatus of claim 4, wherein the supporter further includes
a crushing member configured to crush ice attached on a surface of the fixed support when the vertical reciprocating member is vertically moved along the fixed support.

7. An artificial freezing method used for an artificial freezing apparatus, the method comprising:
(A) moving downwardly a vertical reciprocating member under the surface of water by receiving a driving force of a first chain;
(B) rotating positions of an upper and a lower cooling member by receiving a driving force of a second chain when the vertical reciprocating member is moved downwardly under the surface of the water in step (A);
(C) putting the apparatus on standby while ice produced in the upper cooling fan falls down into the surface of the water; and
(d) moving upwardly the vertical reciprocating member over the surface of the water by receiving the driving force of the first chain when some water is accommodated in the lower cooling fan whose position is switched to face upwardly in step (B).

8. The method of claim 7, further comprising:
repeating vertical reciprocating movement of the vertical reciprocating member a predetermined number of times by receiving the driving force of the first chain when the ice produced in the upper cooling fan has not fallen down into the surface of the water.
